(19) United States
(12) Patent Application Publication
(10) Pub. No.: US 2021/0273353 A1
(43) Pub. Date: Sep. 2, 2021

(54) Terminal Board

(71) Applicant: Fujicon Kabushikikaisya, Tokyo (JP)

(72) Inventor: Oshima Ukyo, Tokyo (JP)

(73) Assignee: Fujicon Kabushikikaisya, Tokyo (JP)

(21) Appl. No.: 17/260,201

(22) PCT Filed: Jul. 12, 2019
(86) PCT No.: PCT/JP2019/027818

§ 371 Date: Jan. 13, 2021

(30) Foreign Application Priority Data
Jul. 13, 2018 (JP) 2018-133355
Jan. 26, 2019 (JP) 2019-011747

(51) Int. Cl. H01R 9/24; H01R 4/48; H01R 4/30; H01R 4/34; H01R 11/12

(52) U.S. Cl. CPC H01R 9/24; H01R 4/48; H01R 11/12; H01R 4/34; H01R 4/305

(57) ABSTRACT

The invention provides a terminal board wherein a crimp terminal is positioned in a predetermined position regardless of an insertion face, the terminal board has excellent workability in that a falling out can be prevented irrespective of a maker and a part number and regardless of a form of the crimp terminal, the terminal board has wide compatibility, and an electric wire can be prevented from falling out. The terminal board includes an insertion opening into which a crimp terminal including a neck portion and an enlarged portion is inserted, a base formed of a conductive material, a holding member that holds the crimp terminal between the holding member and the base, and a bolt that fastens the holding member to the crimp terminal or a lever that controls a state of the holding member holding the crimp terminal, wherein an engagement portion including a pair of protrusions protruding upward from the base is provided from an end face of the insertion opening on either width direction side of the base. Also, the engagement portion is provided in such a way as to be replaceable in accordance with widths of the neck portion and the enlarged portion of the crimp terminal. Because of this, the crimp terminal is positioned in a predetermined position when inserted, and the enlarged portion is engaged with the protrusions, whereby the crimp terminal is prevented from falling out.

### TECHNICAL FIELD

The present invention relates to a structure of a terminal board to which a crimp terminal portion of an electric wire is connected, and in particular, relates to a terminal board characterized by being configured in such a way that the crimp terminal is positioned in a predetermined insertion position, the electric wire does not fall out of the terminal board, and the electric wire is not pulled out even when a pulling force acts on the electric wire, regardless of a form of the crimp terminal (an R-type terminal or a Y-type terminal) and a way in which the crimp terminal is inserted when inserting the crimp terminal (whether a bulging portion of a core wire crimping portion is at the top or at the bottom).

### BACKGROUND ART

A terminal board is a base to which an end portion of an electric wire is connected, and is used with an object of electrically connecting a multiple of power lines or signal lines to each other. Because of this, an input port and an output port are provided in the terminal board, and the two are connected by a conductive metal base.

An end portion of an electric wire attached to a terminal board rarely being used as a bare wire, a crimp terminal is normally attached to the end portion of the electric wire, and the crimp terminal is connected to the terminal board. As typical crimp terminal forms, there are a round terminal (an R-type terminal) and a type of terminal whose leading end is opened (a Y-type terminal). An R-type terminal is formed of a washer-form annular thin plate having a circular hole in a center, a neck portion is provided on an outer side of one portion thereof, and an electric wire is connected. A Y-type terminal is such that a neck portion is provided in a rear of a horseshoe-form thin plate whose front is opened, and an electric wire is connected. In the specification, the annular thin plate and the neck portion of an R-type terminal, and the horseshoe-form thin plate and the neck portion of a Y-form terminal, are collectively called a tongue portion.

FIG. 17 is a drawing showing forms of a round crimp terminal and a Y-type terminal, and various kinds of dimension of copper wire-use bare Y-type terminals with part numbers of a certain crimp terminal manufacturer. A crimp terminal has JIS standards, UL standards, and the like, and a compatible screw diameter (Φ) of the crimp terminal is specified as 3.0, 3.5, 4.0, or the like by such standards. For example, when the compatible screw diameter is 3.5, d2 (a dimension that allows a screw with a diameter of 3.5 mm to be inserted) shown in FIG. 17 is specified as being 3.7 mm. Meanwhile, even when compatible screw diameters are the same, dimensions of an enlarged place (an enlarged portion) in the crimp terminal such as a width (B), a length (F) from the neck portion to a center of a screw insertion portion, an overall length (L) of the crimp terminal, and a length (E) of a core wire crimping portion are not particularly specified by the standards. Because of this, these dimensions (the dimensions not prescribed by the standards) differ in accordance with the maker or the part number. That is, even when compatible screw diameters are the same, dimensions not prescribed by standards (B, F, L, E, and the like) differ for each maker and part number. The same applies to standards of an R-type terminal.

As typical structures of a terminal board to which these crimp terminals are connected, there are a screw fastening type terminal board and a screwless terminal board. A conventional method of using a basic terminal board is a method whereby an R-type terminal is connected to a screw fastening type terminal board. This method is such that, using a pressure contact plate having a circular hole, and arranging in such a way that positions of the circular hole of the R-type terminal and the circular hole of the pressure contact plate coincide, the R-type terminal is fixed by fastening the pressure contact plate using a screw.

The method whereby an R-type terminal is fixed using the screw fastening type terminal board is such that an inner face of the circular hole of the R-type terminal is restrained by a screw, because of which it hardly ever happens that the R-type terminal falls out, even when a pulling force acts on the electric wire. However, attaching and detaching an R-type terminal using this method has a problem in that work such as loosening the screw, removing the screw, inserting the R-type terminal in a screw hole, and tightening the screw again involves an extremely large amount of time and trouble.

Because of this, using a Y-type terminal instead of an R-type terminal is conceivable. In the case of a Y-type terminal, it is sufficient that a screw is loosened to an extent that a terminal board can be slid into a gap between upper and lower pressure contact plates, and the time and trouble involved in the work of attaching and detaching the crimp terminal is considerably reduced.

FIG. 16 is a drawing illustrating work of connecting a Y-type terminal to abase 110 of a screw fastening type terminal board 100 by fastening with a screw 120. The base 110 is a conductive body for electrically connecting an input side and an output side. The input and output sides become continuous by a Y-type terminal being inserted from both sides and fixed to the base 110 with the screw 120. Herein, insertion of a crimp terminal into a terminal board is carried out in many cases from a lower side, as shown in FIG. 16(c). This is because disposing an electric wire inside the terminal board in a vertical direction is preferable in terms of space and in terms of arranging the wiring. Also, regarding faces when inserting the crimp terminal, the crimp terminal is inserted in such a way that a bulging portion of a core wire crimping portion 7 is at the top, as shown in FIG. 16(a). This is because when the core wire crimping portion 7 is at the bottom, as in FIG. 16(d), the core wire crimping portion 7 comes in contact with the base 110 or a flat plate portion of a terminal block 100, and a crimp terminal 2 cannot be inserted normally. Because of this, an operator has to adjust an orientation of the crimp terminal 2 before inserting. Further, the Y-type terminal 2 is inserted into an insertion opening of the terminal board from below, and fastened with a screw, but when carrying out such work, the Y-type terminal 2 has to be held in one hand while fastening the screw 120 with a screwdriver held in the other hand. Because of this, problems such as the Y-type terminal falling, the crimp terminal moving left and right, or the crimp terminal being screwed down diagonally occur. Furthermore, a problem occurs in that the crimp terminal has to be accurately inserted as far as a position in which screwing can be carried out, regardless of a form of the crimp terminal, a type of crimp screw fastening, and a lever type.

Also, a Y-type terminal is such that a force restraining the terminal is weak in comparison with that of a round terminal, and there is a problem in that unless the screw is fastened extremely tightly, the electric wire falls out when a strong pulling force acts on the electric wire. Furthermore, there is a problem with the screw type terminal board 100 in that only a crimp terminal compatible with the screw diameter thereof can be connected.

Meanwhile, proposals for a screwless terminal board have been made in recent years in order to completely eliminate the time and trouble involved in screw fastening in a terminal board. For example, a lever type terminal device wherein a terminal fitting is pressed downward using a cam lever, and a crimp terminal is clamped between upper and lower pieces of the terminal fitting, is disclosed in Patent Literature 1.

A configuration wherein, furthermore, a through hole is provided in the upper and lower pieces of the terminal fitting in the lever type terminal device, and fastening is carried out by a protrusion disposed on a back face of the cam lever being passed through the through holes and a central space portion of an R-type terminal, whereby the R-type terminal is prevented from falling out, is also disclosed.

Also, a terminal block (and a terminal block manufacturing method) wherein a crimp terminal is pressed down by a lever pressing force is also disclosed in Patent Literature 2. The terminal block includes a base that electrically connects the terminal block to a terminal, a first biasing member formed of a plate spring that biases the terminal toward the base, and a lever that can pivot between an initial position and a standby position and pushes the first biasing member upward in the standby position.

Further, a configuration is such that when a crimp terminal is inserted into the terminal block, a stopper moves from a second position to a first position, the stopper is pressed down by a lever biased from behind by a spring, and the crimp terminal is held so as not to fall out. Because of this, the crimp terminal can be attached and detached with one touch.

Also, a configuration wherein an electric wire is prevented from falling out by a protrusion being provided in a pressing portion of a biasing member that presses a terminal down, and the protrusion being caused to protrude through a central space portion of an R-type terminal, is also disclosed for the terminal block of Patent Literature 2.

A terminal block wherein an end portion of a lead, or a terminal member provided on an end portion of a lead, can be connected by operating a lever is disclosed in Patent Literature 3. With regard to the terminal block of Patent Literature 3, technology whereby claw pieces are provided across a certain interval on a leading end front side of a thin plate member that presses the crimp terminal down when fixing an open-tip type crimp terminal, and the claw pieces engage with a stepped portion (neck portion) formed at a boundary between a terminal portion of the open-tip type crimp terminal and the lead, thereby enabling retention of the crimp terminal, is disclosed.

In addition to the lever type, various types of terminal block have been proposed as screwless terminal blocks. As specifications are also provided in JIS standards, the screw fastening terminal block can be said to be technology that is established to a certain extent. Meanwhile, the screwless terminal block is currently in a process of development and improvement, and the current situation is thought to be that the screwless terminal block cannot yet be said to be established from a technical aspect.

A round terminal fixing structure wherein a pair of protrusions (upright pieces 42 and 142) protruding upward from the base are provided in such a way as to oppose each other on either width direction side of the base, which faces an insertion opening in which a round terminal including a neck portion and an enlarged portion is inserted, is disclosed in Patent Literature 4. However, the pair of protrusions described in Patent Literature 4 are provided in order to easily set the round terminal in a fixing position (above a second through hole through which a bolt is inserted), to prevent an assembly failure (fastening in a state wherein the round terminal is raised above a rotation restricting piece), and to restrict rotation when fastening the round terminal with a screw.

### CITATION LIST

### Patent Literature

Patent Literature 1: JP-UM-A-63-63968

Patent Literature 2: JP-A-2017-91729

Patent Literature 3: Japanese Patent No. 3,253,202

Patent Literature 4: JP-A-2014-220933

### SUMMARY OF INVENTION

### Technical Problem

When using a Y-type terminal in a screw fastening type terminal board, as heretofore described, there are problems in that workability is poor, with the screw having to be tightened with one hand and the Y-type terminal falling, or the like, the crimp terminal moves left and right when fastening, or the crimp terminal is screwed down diagonally. Also, when inserting the crimp terminal, there is a problem in that the crimp terminal has to be inserted in such a way that the bulging portion of the core wire crimping portion is at the top (the tongue portion of the crimp terminal is at the bottom), regardless of the form of the crimp terminal. Furthermore, the force restraining a Y-terminal is weak in comparison with that of a round terminal, and there is a problem in that unless the screw is fastened extremely tightly, the electric wire falls out when a strong pulling force acts on the electric wire.

A lever type terminal block is such that a crimp terminal pressed down by a base and a plate spring is fixed by being pressed down by a holding plate of a cam lever, or by being pressed down by a spring force of the plate spring. As already described, however, the pressing force of a plate spring is such that resistance with respect to the pulling force of an electric wire is insufficient in comparison with that of screwing.

Because of this, a method whereby a through hole is provided in upper and lower pieces of a terminal fitting, and fastening is carried out by a protrusion disposed on a back face of a cam lever being passed through a central space portion of an R-type terminal, whereby the R-type terminal is prevented from falling out, is employed in Patent Literature 1. Also, a method whereby an electric wire is prevented from falling out by a protrusion being provided in a pressing portion of a biasing member, and the protrusion being caused to protrude through a central space portion of an R-type terminal, is employed in Patent Literature 2. Furthermore, in Patent Literature 3, a configuration is such that two claw pieces formed at a leading end of a holding plate engage with a stepped portion formed at a boundary between a terminal portion of an open-tip type crimp terminal and a lead.

However, such a method whereby “a protrusion is fitted into a central space portion of an R-type terminal” has a stopper function with respect to an R-type terminal, but in the case of a Y-type terminal, a leading end is opened, because of which the stopper function does not work. Also, the method described in Patent Literature 3 whereby engaging is carried out by two claw pieces formed at a leading end of a holding plate has a problem in that engaging cannot be carried out when a dimension or the like of a neck portion of a crimp terminal differs (there is a lack of versatility). Also, the claw piece described in Patent Literature 3 is formed by a leading end of a thin plate member that presses down on a crimp terminal being bent to a front side, because of which a pulling force acts perpendicularly with respect to a longitudinal width direction of the claw piece. Providing a claw piece of such a form with strength to resist a pulling force is not easy. This is because the thin plate member is easily bent and easily restored. Although the claw piece can be provided with a predetermined strength by increasing a width of the claw piece (reducing the interval between claw pieces), the interval between claw pieces decreases in such a case, and crimp terminals with which the claw pieces can engage are limited. Meanwhile, there is a difficult problem in that although crimp terminals with which the claw pieces can engage increase when the interval between claw pieces is increased, strength to resist a pulling force decreases.

The protrusion (upright piece) described in Patent Literature 4, as heretofore described, is provided in order to prevent an assembly failure (fastening in a state wherein the round terminal is raised above a rotation restricting piece) when fastening a round terminal with a screw, and to restrict rotation when fastening with a screw, rather than preventing a falling out of a crimp terminal. Because of this, the protrusion may be provided on one side only (one protrusion) or, when provided in such a way as to oppose, an interval between protrusions has to be such that a neck portion of a round terminal is sandwiched with no gap (no looseness). Because of this, there is a problem in that the protrusion described in Patent Literature 4 cannot be applied as retention for crimp terminals of various makers, or for crimp terminals of differing part numbers, even when the maker is the same. Also, even when inserting a round crimp terminal in a lever type terminal board, there are problems in that the crimp terminal has to be inserted in such a way that a core wire crimping portion is on top, and the crimp terminal has to be inserted accurately as far as a predetermined position. Furthermore, there is a problem in that the crimp terminal cannot be inserted with a bulging portion of the core wire crimping portion of the crimp terminal on the bottom.

Therefore, a first problem of the invention is to provide a terminal board with good workability wherein a crimp terminal is positioned in a predetermined position, regardless of whether a bulging portion of a core crimping portion of the crimp terminal is at the top or at the bottom when inserting the crimp terminal. A second problem of the invention is to provide a terminal board with excellent workability, and wide adaptability (excellent versatility), wherein even a Y-type terminal can be prevented from falling out, regardless of maker or part number, provided that at least compatible screw diameters are the same.

Next, a third problem of the invention is to provide a terminal board that is a lever type terminal board wherein a crimp terminal is fixed by a pressing force of a lever, and a falling out of an electric wire can be prevented by a stopper function acting, regardless of whether the crimp terminal is an R-type terminal or a Y-type terminal.

Also, a lever type terminal board, wherein a force fixing a crimp terminal is weak compared with that of a screw fastening type, is such that there are cases wherein an external force acts on an electric wire attached to the terminal board, and the crimp terminal moves left and right, and there is a problem in that in not a few cases contact faces of the terminal and a base or the like become oxidized by air, contact resistance increases, and heat is generated.

Therefore, a fourth problem of the invention is to provide means whereby a crimp terminal attached to the terminal board can be prevented from moving left and right in a lever type terminal board, whereby heat generation trouble caused by an increase of contact resistance may be prevented.

### Solution to Problem

An invention for resolving the heretofore described problems is a terminal board including an insertion opening into which a crimp terminal including a neck portion and an enlarged portion is inserted, a base formed of a conductive material and extending in a back side direction from the insertion opening, a holding member that holds the crimp terminal inserted from the insertion opening between the holding member and the base, and a bolt that fastens the holding member to the crimp terminal or a lever that controls a state of the holding member holding the crimp terminal, wherein an engagement portion including a pair of protrusions opposing across an interval wider than a neck portion with a maximum width among neck portions of crimp terminals used in the terminal board, and narrower than an enlarged portion with a minimum width, is provided from an end face of the insertion opening, and an insertion position of the crimp terminal is determined by a core crimping portion of the crimp terminal coming into contact with the protrusions, the base, or an end face of a frame of the terminal board when the crimp terminal is inserted.

A core wire crimping portion of a crimp terminal is a place that clamps and connects a tongue portion (an enlarged portion and a neck portion) and an electric wire, and while the tongue portion is flat, the core wire crimping portion has a certain bulge (thickness). Because of this, a crimp terminal has conventionally been inserted in such a way that the bulging portion of the core wire crimping portion faces upward (the tongue portion is at the bottom), thereby preventing the core wire crimping portion from rising up onto a base, a projecting portion, or the like. However, by providing a pair of protrusions in a crimp terminal insertion opening from an end portion thereof, the core wire crimping portion comes in contact with the protrusions when the crimp terminal is inserted in a state wherein the bulging portion of the core wire crimping portion is at the top, and the crimp terminal is positioned in a predetermined position without being further inserted. When the crimp terminal is inserted in a state wherein the bulging portion of the core wire crimping portion is at the bottom, the bulging portion of the core wire crimping portion comes in contact with a side face of the base or a side face of the projecting portion, and the crimp terminal is positioned in a predetermined position. When the base or the projecting portion does not extend as far as the end portion of the insertion opening, the core wire crimping portion comes in contact with a side face of a terminal board frame, and the crimp terminal is positioned in a predetermined position. Because of this, a crimp terminal can be inserted to a predetermined position without taking an insertion direction of the crimp terminal into consideration. A predetermined position in a case of a screw fastening type terminal board is a position in which a screw hole in an annular thin plate or a horseshoe-form thin plate of the tongue portion and a screw can fit together appropriately, and in a case of a lever type terminal board, a predetermined position is a position in which an annular thin plate or a horseshoe-form thin plate of the tongue portion is properly pressed down by the holding member.

A terminal board including an insertion opening into which a crimp terminal including a neck portion and an enlarged portion is inserted, a base formed of a conductive material and extending in a back side direction from the insertion opening, a holding member that holds the crimp terminal inserted from the insertion opening between the holding member and the base, and a bolt that fastens the holding member to the crimp terminal or a lever that controls a state of the holding member holding the crimp terminal, is a terminal board characterized in that an engagement portion including a pair of protrusions opposing across an interval wider than a neck portion with a maximum width among neck portions of crimp terminals used in the terminal board, and narrower than an enlarged portion with a minimum width, is provided in the insertion opening in such a way as to be replaceable in accordance with a form and dimensions of the crimp terminal, and the enlarged portion is engaged with the protrusions when the crimp terminal is inserted, thereby being prevented from falling out.

By an engagement portion including a pair of protrusions such that an interval between the pair of protrusions is wider than a maximum dimensional value of neck portions of a multiple of crimp terminals used in a terminal board, and narrower than a minimum dimension of an enlarged portion, being replaced in accordance with a form and dimensions of a crimp terminal used, the crimp terminal can be used even when a maker or a part number differs, and a falling out and a lateral deflection of the crimp terminal can be prevented.

When a projecting portion (chin) is provided in an upper portion of the protrusion with which the enlarged portion of the crimp terminal comes in contact, a pulling out of the crimp terminal can be more reliably prevented owing to the presence of the projecting portion (chin), even when a pulling force in a diagonally upward direction acts on the crimp terminal.

Furthermore, by a pair of claws protruding downward being provided on either width direction side end of a leading end portion of a holding member of a lever that controls a holding state of the crimp terminal, a lateral direction deflection of the crimp terminal can be prevented, because of which heat generation trouble caused by an increase in contact resistance of the crimp terminal can be prevented.

### Advantageous Effects of Invention

The terminal board of the invention is such that by providing a pair of protrusions in a crimp terminal insertion opening from an end portion thereof, the crimp terminal can be inserted to a predetermined position regardless of whether the crimp terminal is inserted in a state wherein a bulging portion of a core wire crimping portion is at the top or inserted in a state wherein the bulging portion is at the bottom, and positioned in the predetermined position. Because of this, consideration of a crimp terminal insertion direction, and confirming whether or not the crimp terminal has been inserted as far as a predetermined insertion position, are unnecessary, and a terminal board with considerably improved workability can be provided. Also, by providing an engagement portion including a pair of protrusions at a width greater than a neck portion with a maximum width of neck portions among a multiple of crimp terminals used, and narrower than an enlarged portion with a minimum width among enlarged portions, in a vicinity of a crimp terminal insertion opening in such a way as to be replaceable, a terminal board such that a falling out of a crimp terminal can be prevented, regardless of a crimp terminal maker or part number, can be provided. Also, a terminal board such that an enlarged portion of a crimp terminal comes into contact with a pair of protrusions owing to a force being caused to act in a pulling direction after the crimp terminal is inserted, and the pair of protrusions function in such a way as to prevent a pulling out and prevent a lateral deflection of the crimp terminal, can be provided.

Regardless of whether a crimp terminal is an R-type terminal or a Y-type terminal, having an enlarged portion at a base of a neck is common to both, because of which, according to the configuration of the invention, a falling out and a lateral deflection of the crimp terminal are prevented for both an R-type terminal and a Y-type terminal, and heat generation trouble caused by an increase in contact resistance can be prevented.

### DESCRIPTION OF EMBODIMENTS

Hereafter, a preferred embodiment of the invention will be described, with reference to drawings of working examples. FIG. 1 is a drawing showing an external appearance of a screw fastening type terminal board 100, which is a first working example of the invention, wherein FIG. 1(a) is a perspective view before a crimp terminal 2 is inserted into the terminal board 100, and FIG. 1(b) is a perspective view after the crimp terminal 2 is inserted into the terminal board 100 and fastened with a screw 120. FIG. 1(c) is a perspective view showing work of connecting the Y-type crimp terminal 2 to the terminal board 100 from below. As heretofore described, disposing an electric wire inside a terminal board in a vertical direction is preferable in terms of space and in terms of arranging the wiring, because of which an insertion opening of the terminal board faces downward in many cases. Because of this, work of connecting to the terminal board involves inserting a crimp terminal from below, the crimp terminal has to be inserted with one hand while fastening the screw 120 with a screwdriver held in the other hand, and workability is poor, with the Y-type terminal falling or the like.

However, an engagement portion 40 including a pair of protrusions 41 is formed in an insertion opening of the terminal board 100 of the first working example, meaning that even in a state before fastening with the screw 120, an enlarged portion 5 of the crimp terminal comes into contact with the protrusions 41, the Y-type terminal does not fall, and an operator can use both hands. Because of this, problems of the Y-type terminal falling, the Y-type terminal being fastened diagonally, insufficient screw fastening, and the like, which are existing problems, can be eliminated. Furthermore, even when a strong pulling force is exerted on the Y-type terminal, the enlarged portion 5 comes into contact with the protrusions 41, and pulling out can be prevented.

Herein, a form and dimensions of a crimp terminal are such that, while screw diameters are the same or different as shown in FIG. 17, a width of a neck portion 4, a width (B) of the enlarged portion 5, a length from the neck portion 4 to a leading end of the enlarged portion, and the like, differ even when the screw diameter is the same. Because of this, the engagement portion 40 needs to be an engagement portion that is in accordance with the form and dimensions of the crimp terminal, and existing technology is such that a screw fastening type terminal board that is in accordance with a crimp terminal part number (form and dimensions) is needed.

FIG. 2 is a perspective view and a sectional view of the screw type terminal board 100, wherein the engagement portion 40 is formed as a die type flush with an end face of a left side face 130 of a frame in the screw fastening type terminal board 100 shown in FIG. 1. FIG. 2(a) is a perspective view before the crimp terminal 2 is inserted into the terminal board 100 with a bulging portion of a core wire crimping portion 7 at the top, and FIG. 2(b) is a sectional view after the crimp terminal 2 is inserted into the terminal board 100, and the core wire crimping portion 7 comes into contact with the engagement portion 40, is positioned in a predetermined position, and is fastened with the screw 120. FIG. 2(c) is a perspective view before the crimp terminal 2 is inserted into the terminal board 100 with the bulging portion of the core wire crimping portion 7 at the bottom, and FIG. 2(d) is a sectional view after the crimp terminal 2 is inserted into the terminal board 100, and the core wire crimping portion 7 comes into contact with the left side face 130 of the frame, is positioned in a predetermined position, and is fastened with the screw 120. FIG. 3(a) is an enlarged sectional view before the crimp terminal 2 is inserted into the terminal board 100 with the bulging portion of the core wire crimping portion 7 at the top, and FIG. 3(b) is an enlarged sectional view before the crimp terminal 2 is inserted into the terminal board 100 with the bulging portion of the core wire crimping portion 7 at the bottom.

FIG. 4 is a drawing showing a structure that enables attachment and detachment of the engagement portion 40, which is an embodiment of the invention. The engagement portion 40 shown in FIG. 4 is such that a support pile 44 for fixing to the terminal board in such a way as to be attachable and detachable is formed in a bottom portion of the protrusion 41. A structure is such that the support pile 44 is fixed to the terminal board 100 by being pressed into a terminal board support hole (not shown) and locked, and the lock can be released and the support pile 44 removed by the support pile 44 being pressed in again. By adopting a structure such that the engagement portion 40 can be replaced (can be exchanged) in the terminal board 100, and replacing the engagement portion 40 in accordance with a crimp terminal part number, a terminal board that can be used for crimp terminals of various part numbers (a terminal board with versatility) can be obtained. In FIG. 4, the engagement portion 40 is formed backward in an insertion direction from an end face of the crimp terminal insertion opening, but by the engagement portion 40 being formed from an end portion of the insertion opening of the crimp terminal 2, as shown in FIG. 2 and FIG. 3, and the end portion being formed in such a way as to be flush with the left side face 130 of the frame, the crimp terminal 2 can be positioned in a predetermined position, regardless of the way in which the crimp terminal 2 is inserted into the insertion opening.

FIG. 5 is a perspective view and a sectional view of a lever type terminal board 1, wherein the engagement portion 40 is formed as a die type flush with the left side face 130 of a frame 3 in the lever type terminal board 1, which is a second working example of the invention. FIG. 5(a) is a perspective view before the crimp terminal 2 is inserted into the terminal board 1 with the bulging portion of the core wire crimping portion 7 at the top, and FIG. 5(b) is a sectional view after the crimp terminal 2 is inserted into the terminal board 100, and the core wire crimping portion 7 comes into contact with the engagement portion 40, is positioned in a predetermined position, and is pressed down by a lever. FIG. 5(c) is a perspective view before the crimp terminal 2 is inserted into the terminal board 1 with the bulging portion of the core wire crimping portion 7 at the bottom, and FIG. 5(d) is a sectional view after the crimp terminal 2 is inserted into the terminal board 1, and the core wire crimping portion 7 comes into contact with the left side face 130 of the frame, is positioned in a predetermined position, and is pressed down with the lever.

FIG. 6 is a drawing showing an external appearance of a lever type terminal board in which no screw is used, which is the second working example of the invention, wherein FIG. 6(a) is a sectional view of the whole terminal board, and FIG. 6(b) shows a perspective view of a left-side half. As seen in FIG. 6(a), the terminal board 1 has bilateral symmetry with a longitudinal direction center thereof as a reference. A configuration is such that crimp terminals 2 can be inserted from insertion openings in both longitudinal direction side faces, wherein one corresponds to an input line, and the other corresponds to an output line.

Herein, an input side and an output side have plane symmetry and have the same form left and right, because of which, in order to facilitate matters, only one side is displayed in many cases in the following drawings and description, and only that portion is described. As seen in FIG. 6, the terminal board 1 is configured of parts such as the frame 3, a base 10, a holding member 20, and a lever 30.

The protrusion 41 configuring the engagement portion 40 is formed in a crimp terminal insertion opening of the terminal board 1. A perspective view, and an enlarged view of one portion thereof, are shown in FIG. 6(b), but the engagement portion 40 includes the pair of protrusions 41, formed one on either side of the insertion opening, and a groove portion 42 through which the neck portion 4 (refer to FIG. 17 and the like) of the crimp terminal 2 is inserted. The protrusion 41 shown in FIG. 6 is formed from an end face of the crimp terminal insertion opening, and an end portion of the protrusion 41 is flush with the left side face of the frame 3 of the terminal board 1. Also, a state wherein the crimp terminal 2 is inserted with the core wire crimping portion 7 at the top and the tongue portion 8 at the bottom is shown.

FIG. 7 is exploded views showing a structure and a form of parts of the terminal board 1, wherein FIG. 7(a) shows a perspective view of the base 10, FIG. 7(b) shows a perspective view of the holding member 20, FIG. 7(c) shows a perspective view of the lever 30, and FIG. 7(d) shows a sectional view of the lever 30. Hereafter, each of these parts will be described. As previously mentioned, the base 10 and the holding member 20 are bodies wherein left and right sides are linked, but mainly a portion on one side only is shown. The lever 30 is a pair of independent parts, one each on the left and the right, wherein the pair are disposed symmetrically.

Firstly, the frame 3 is a box-form body forming a case that houses parts such as the base 10, the holding member 20, and the lever 30 in an interior thereof. Details of a structure and a form of the frame 3 will be omitted, but as the frame 3 needs to at least be an insulating body, it is preferable from the aspects of insulation and processability that the frame 3 is made of plastic.

The base 10 is used for electrically connecting the input side and the output side, and is configured by articles with bilateral symmetry being integrated, but mainly a left-side half only thereof is shown in FIG. 7(a). The base 10 is formed of a frame body wherein the holding member 20 is attached to an upper portion thereof, and the lever 30 is housed in an interior thereof.

That is, the base 10 has a reverse U-shaped cross-section, enclosed by a side wall 11 on either side and a projecting portion 12, wherein a lower portion is opened. An upper face on a front side (in this specification, a side in the longitudinal direction of the terminal board from which a crimp terminal is inserted is called a “front side”, and a side opposite thereto is called a “central side”) of the projecting portion 12 is a face that is in contact with the crimp terminal 2, and is of a flat form.

A cutout space 13 is formed in a center of the base 10, and the cutout space 13 is a space for housing the lever 30 in an interior thereof. Because of this, a semi-circular bearing 14 is formed in a bottom portion of the side wall 11 on both cutout sides. The bearing 14 is for supporting a rotary axis 33 provided in a vicinity of a lower end of the lever 30.

Also, a rectangular cutout portion 15 is formed in a vicinity of a center of a front side vertical face of both side walls 11. The cutout portion 15 is provided for attaching the base 10 to the frame 3. A material of the base 10 need not be particularly limited provided that the material is a conductive metal, and in this working example, the base 10 is fabricated by processing a copper plate.

The holding member 20, as seen in FIG. 7(b), is fabricated by bending a longitudinal direction of a strip-form plate spring into several sections, and a horizontal portion 21, an inclined portion 22, an upper curved portion 23, and a lower curved portion 24 are formed in order of proximity to the front side.

The horizontal portion 21 is a region that presses the crimp terminal 2 down onto the projecting portion 12, and the inclined portion 22 is a region with which the lever 30 comes into contact, and which presses the holding member 20 up, as will be described hereafter. Also, the upper curved portion 23 is a region for increasing elastic resilience of the plate spring, and the upper curved portion 23 is a region for fixing the holding member 20 to the frame 3. In this working example, a spring-use stainless steel plate with a thickness of 0.5 mm or greater of the holding member 20 is used.

The lever 30 is configured of a gripping portion 32, the rotary axis 33, a lower block 34, and the like, whose side faces are attached to a pair of parallel support plates 31, as seen in FIG. 7(c). The rotary axis 33 is fitted into the bearing 14 of the base 10, and supports the lever 30 in such a way that the lever 30 can rotate. A rotation range of the lever 30 is limited to a predetermined range by a front face 35 and a back face 36 of the gripping portion 32 coming into contact with two stoppers provided on an inner wall of the frame.

Also, a head portion of the lower block 34 of the lever 30 is of a unique form, wherein an apex portion forms a contact portion 37, and an inclined portion on one side of the head portion forms an opposing portion 38, as seen in FIG. 7(d). A form of the head portion is formed in order to move the holding member 20, as will be described hereafter.

The lever 30 is such that at least the support plate 31 and the grip 32 need to be insulating bodies, because of which articles made of plastic are used for the two, and a metal material such as stainless steel is used for the other regions in this working example.

Herein, the engagement portion 40 is formed from an end face of an end portion on the crimp terminal 2 insertion side of the projecting portion 12. A length of the engagement portion 40 in the insertion direction is formed to be a length that does not hinder a pressing down of the tongue portion 8 by the flat plate 21. Also, the flat plate 21 is provided in a position such that the tongue portion 8 can be pressed down appropriately. The above factors mean that when inserting with the bulging portion of the core wire crimping portion 7 at the top, the bulging portion comes into contact with the protrusion 41 and is positioned, and when inserting with the bulging portion of the core wire crimping portion 7 at the bottom, the bulging portion comes into contact with aside face of the projecting portion 12, and cannot be inserted further, and the crimp terminal 2 is positioned in a predetermined position. Also, the engagement portion 40 includes the protrusions 41 formed one on either side at the front side, and the groove 42 through which the neck portion 4 of the crimp terminal 2 is inserted between the protrusions 41. A width of the groove 42 is formed to be greater than a width of the neck portion 4 of the crimp terminal 2 and smaller than a width of the enlarged portion 5 of the crimp terminal, whereby the enlarged portion 5 is engaged with the protrusions 41.

FIG. 8 is a drawing showing an example of a structure of the engagement portion 40. The engagement portion 40 shown in FIG. 8 is such that the support pile 44 for fixing to the terminal board in such a way as to be attachable and detachable is formed in a lower portion of the protrusion 41. The support pile 44 is fixed to the terminal board 1 by being pressed into a terminal board support hole (not shown) and locked, and the lock can be released and the support pile 44 removed by the support pile 44 being pressed in again. By providing the engagement portion 40 in such a way as to be replaceable (exchangeable) in the terminal board 1, which is a lever type terminal board, and replacing the engagement portion 40 in accordance with a crimp terminal part number, a terminal board that can be used for crimp terminals of various part numbers (a terminal board with versatility) can be obtained. For example, an engagement portion wherein the width of the groove 42 is equal to or greater than a maximum width 1.7 mm of a neck portion, and equal to or smaller than a minimum width 5.7 mm of an enlarged portion, is employed in a terminal board in which a crimp terminal whose compatible screw diameter is from 3.0 to 3.5 is used. Also, the engagement portion 40 wherein the width of the groove 42 is equal to or greater than a maximum width 9.0 mm of a neck portion, and equal to or smaller than a minimum width 10.9 mm of an enlarged portion, is employed in a terminal board in which a crimp terminal whose compatible screw diameter is from 8.0 to 8.4 is used. By replacing the engagement portion 40 in accordance with the part number of a crimp terminal used in this way, a terminal board that can be used for crimp terminals of various part numbers (a terminal board with versatility) can be obtained.

FIG. 9 is sectional views for describing an operation of a lever in the terminal board of this working example, wherein FIG. 9(a) shows a standby state (a state of waiting for an insertion of a crimp terminal) and FIG. 9(b) shows a fastened state. In a standby state, the lever 30 is in an inverted state, and the contact portion 37 of the lower block 34 is in contact with the inclined portion 22 of the holding member 20, pressing the inclined portion 22 up. Because of this, a leading end side of the horizontal portion 21 is raised up, and a gap into which the crimp terminal 2 is inserted is formed between the horizontal portion 21 and the projecting portion 12 configuring the base 10.

By the lever 30 being placed in an upright state after the crimp terminal 2 is inserted, the contact portion 36 separates from the holding member 20, and the opposing portion 38 of the lower block 34 opposes a back face of the inclined portion 22 of the holding member across a gap of a certain extent. In this state, the horizontal portion 21 is pressed down onto an upper face of the crimp terminal 2 by the resilience of the spring of the holding member 20, reaching a fastened state. This lever type terminal board is characterized in that the crimp terminal 2 is pressed down by the resilience of the plate spring of the holding member 20, and the pressed-down state is released (or controlled) by the lever 30.

A terminal board having such a structure is a configuration widely used in existing lever type terminal boards, and is not a configuration unique to the invention. A configuration unique to the invention is that the engagement portion 40 is provided in the projecting portion 12 configuring the base 10, as will be described hereafter. Hereafter, operational advantages thereof will be described.

FIG. 10 is illustrations of operational advantages of the engagement portion 40 in the terminal board of the second working example, wherein FIG. 10(a) is a perspective view showing a state wherein a Y-type terminal is inserted from the insertion opening of the terminal board 1, the neck portion 4 is inserted through the groove 42 between the protrusions 41, and the enlarged portion 5 is placed on the projecting portion 12, and FIG. 10(b) is a perspective view showing a state wherein a pulling force is exerted on the crimp terminal 2, the enlarged portion 5 comes into contact with the protrusions 41, and pulling out is prevented.

The protrusions 41 configuring the engagement portion 40 are a pair of protrusions of the same form that protrude upward on either leading end side of the projecting portion 12, as seen in FIG. 10(a) and FIG. 10(b). A height h thereof is preferably slightly greater than a thickness of the neck portion or the enlarged portion of the crimp terminal 2. Also, a width between the protrusions 41 is preferably set to be greater than a width of the neck portion 4 or Φd1 shown in FIG. 17, and smaller than a width of the enlarged portion 5 or a width B shown in FIG. 17. Also, it is sufficient that strength of the protrusions 41 is of an extent necessary in order to be likely to withstand a pulling force.

There are several points that are important in order for the engagement portion 40 to exhibit a desired operational advantage. A first point is that a Y-terminal or an R-terminal is inserted along a gentle gradient, and a portion of the crimp terminal ahead of a neck portion is reliably inserted farther inward than the protrusions 41, and reaches a state of being clamped to the base 12 by the holding member 20.

A second point is that by a force being applied in a direction pulling the crimp terminal after the crimp terminal is held down by a spring force of the holding member after insertion, the enlarged portion 5 of the crimp terminal 2 comes into contact with the protrusions 41, and the crimp terminal 2 is housed in a position from which the crimp terminal 2 does not easily fall out even when a pulling force acts. Further, a third point is that after releasing the spring force of the holding member when removing the crimp terminal 2 from the terminal board 1, the crimp terminal 2 can be pulled out easily by pushing the crimp terminal inward, releasing the crimp terminal from the position in contact with the protrusions 41.

The form of the engagement portion 40 in the first working example and the second working example is a form such that a front side angle is close to that of a 30 degree set square when seen from a side face. By adopting such a form, the enlarged portion 5 of a crimp terminal easily comes into contact with the protrusion 41, a large area of contact between the protrusion 41 and the projecting portion 12 can be obtained, and strength likely to easily withstand a pulling force of an electric wire can be obtained. The protrusion 41, not being limited to such a form, may be of a form like a gatepost or an embankment, or of a form such as a rectangular column. That is, provided that an enlarged portion of a crimp terminal comes into contact, and there is strength to withstand a pulling force of an electric wire, the form is not an issue.

Meanwhile, in order to more reliably satisfy the heretofore described points, the kind of form shown in FIG. 11 is preferably adopted for the protrusion 41. The protrusion 41 shown in FIG. 11 includes a projecting portion (chin) 43 in an upper portion of a portion with which the enlarged portion of the crimp terminal 2 comes in contact. By providing the projecting portion (chin) 43 in an upper portion of a portion with which the enlarged portion 5 of the crimp terminal 2 comes in contact, a falling out of the crimp terminal can be more reliably prevented after a Y-type terminal is inserted into the terminal board, even in a state wherein the crimp terminal is not fastened with a screw. Also, in FIG. 11, the protrusion 41 is formed further inward in the insertion direction than the left side face 130 of the frame, but by the protrusion 41 being formed from a place flush with the left side face 130 of the frame, an insertion position of the crimp terminal 2 can be positioned in a predetermined position, regardless of the way in which the crimp terminal 2 is inserted.

By applying the protrusion 41 shown in FIG. 11 to the second working example, a neck portion of a crimp terminal is housed below the projecting portion (chin) 43 of the protrusion 41 by a force being applied in a direction pulling the crimp terminal after the crimp terminal is inserted and held down by a holding member. Because of this, a pulling out of the crimp terminal is more reliably prevented, even when a pulling force in an upper direction is exerted on the crimp terminal.

Next, a lever type terminal board that is a third working example of the invention will be described, using FIG. 12. FIG. 12 is sectional views for describing an operation of a lever in the terminal board of this working example, wherein FIG. 12(a) shows a standby state (a state of waiting for an insertion of a crimp terminal) and FIG. 12(b) shows a fastened state. This terminal board being configured of a frame, a base, a holding member, a lever, and the like is the same as the terminal board of the second working example. Also, as a structure and a form of the frame and the base are practically the same as those of the second working example, details will be omitted. A difference between the two is that in the second working example, an engagement portion is provided in an insertion opening of a terminal board, and an enlarged portion of a crimp terminal is brought into contact with the engagement portion, thereby preventing a pulling out. As opposed to this, the third working example is such that a pair of claws 25 are provided facing downward on either leading end side of a holding member, and an enlarged portion of a Y-type terminal is brought into contact with the claws 25, thereby preventing a pulling out.

FIG. 13 is illustrations of operational advantages of the pair of claws 25 provided on either leading end side of the holding member 20 in a terminal board of the invention, wherein FIG. 13(a) is a form of a straight claw, FIG. 13(b) is a perspective view showing a form of a curved claw, and FIG. 13(c) is a perspective view showing a state wherein a crimp terminal is held by the holding member 20.

As seen in FIG. 13(a), the straight claws 25 are a pair of protrusions of the same form protruding vertically downward on either leading end side of the holding member 20. The height h thereof is preferably of the same extent as the thickness of the neck portion or the enlarged portion of the crimp terminal 2, or slightly smaller than this. Also, a length l and a thickness t of the claw 25 are not particularly limited provided that they are of an extent necessary in order to secure strength of the claw 25, but it is assumed that h≥0.8 mm, I≥2.0 mm, and t≥0.5 mm in this working example.

There are two points that are important in order for a protrusion of the invention to exhibit a desired operational advantage. A first point is that an interval between inner sides of the pair of claws 25 is of a width such that the neck portion 4 of the crimp terminal 2 is held with no looseness. In order to achieve this, a width of a leading end of the holding member 20 is the same as or greater than the width of the neck portion 4, and the claws 25 are formed in such a way as to protrude vertically downward from either end side of the holding member 20 in this working example. By providing claws on either end side of the holding member 20, engagement of an enlarged portion of a crimp terminal can be carried out easily and reliably. Also, as the interval between the pair of claws can be adjusted easily, a terminal board compatible with a greater number of crimp terminals can be obtained. Furthermore, unlike the claw piece described in Patent Literature 3, the pulling force of a crimp terminal acts in a longitudinal width direction of the claw 25 (acts in a direction perpendicular to the thickness of the claw 25). Because of this, a claw that is likely to withstand a pulling force can be formed easily and reliably.

Herein, as a method for being compatible with a greater number of crimp terminals, and holding the neck portion 4 of a crimp terminal with no looseness, it is preferable that the claw 25 is of a curved form having roundness in an outer side direction, as shown in FIG. 13(b), and that a material thereof is a superelastic alloy having a supple elasticity. Owing to the curved claw 25 being formed of a superelastic alloy, a nickel titanium alloy for example, the claws 25 are elastically deformed in a process of an enlarged portion coming into contact with the claws 25 due to a pulling force after the neck portion 4 is inserted through the claws 25, and clamp the neck portion 4 while spreading. By the width between the pair of curved claws 25 being slightly (for example, a difference of 1 mm or less) greater than that of a Y-type terminal among a multiple of Y-type terminals to be used in the relevant terminal board whose neck portion width is the greatest, and smaller than that of the Y-type terminal whose enlarged portion width is the smallest, a terminal board that can be used for a large number of makers and part numbers, and that holds with no looseness, can be provided.

Also, a second important point is that the neck portion of the crimp terminal is reliably positioned in a predetermined position when the crimp terminal 2 is mounted on the terminal board 2. This is because when the position of the neck portion 4 deviates, fitting the neck portion between the pair of claws 25 becomes difficult. A method whereby a guide (not shown) is provided at the back of the projecting portion 12 of the base 10, and positioning is carried out by the leading end of the crimp terminal 2 being brought into contact with the guide, is adopted in this working example. However, it is not necessary that a method of positioning the crimp terminal 2 is limited to this and, for example, a shallow (small-stepped) recession may be provided following an external form of the crimp terminal in a front face of the projecting portion 12, and positioning carried out by a lower face of the crimp terminal inserted into the terminal board fitting into the recession.

Next, a terminal board that is a fourth working example of the invention will be described. This terminal board being configured of a frame, a base, a holding member, a lever, and the like is the same as the terminal boards of the second working example and the third working example. Also, as a structure and a form of the frame and the base are practically the same, details will be omitted. A difference between the two is that structures and functions of the holding members and the levers differ.

FIG. 14 is sectional views showing a form of a part of the terminal board that is the fourth working example of the invention, wherein FIG. 14(a) shows a form of the holding member, and FIG. 14(b) shows a form of the lever. The terminal board of the fourth working example is also such that the holding member 20 is formed of a strip-form plate spring, but the form thereof differs from that of the second working example. The holding member 20 of the fourth working example is such that there is hardly any upper curved portion, and the inclined portion 22 is longer by a commensurate amount.

A reason for no upper curved portion being provided in the holding member 20 is that unlike the case of the second working example, the holding member 20 does not need strong elastic resilience. That is, the reason is that in the second working example, the crimp terminal 2 is pressed down and fixed to the base with the holding member 20 using only the resilience of the spring, but in the fourth working example, the crimp terminal 2 is fixed using a pressing force of a lever (cam lever). In the fourth working example too, the engagement portion 40 is provided in the projecting portion 12 of the base 10 in order to prevent a Y-type terminal from falling out or being pulled out. A configuration of the engagement portion 40 is the same as in the second working example, and although the protrusion 41 of FIG. 12(a) is of a form such that a front side angle is close to that of a 30 degree set square, the protrusion 41 may be a protrusion that includes the projecting portion 43 shown in FIG. 11.

Also, the holding member 20 of the fourth working example is such that an opening angle of the inclined portion 22 (an angle θ between an extension line of the inclined portion and a central vertical line) is greater than that of the second working example. This is in order that a gap in which to insert the crimp terminal 2 is formed between the inclined portion 22 and a lower face of the horizontal portion 21 of the holding member, as shown in FIG. 14(a).

Also, the lever 30 of the fourth working example is the same as the case of the lever of the second working example in that the gripping portion 32 is provided in an upper portion thereof and the rotary axis 33 is provided in a lower portion, and rotation is limited to a predetermined range by the front face 35 and the back face 36 of the gripping portion 32 coming into contact with two stoppers provided on an inner wall of the frame.

A difference from the second working example is that an upper block 39 is provided instead of the lower block 34, and the contact portion 37 and the opposing portion 38 are provided on a lower end of the upper block 39. That is, a difference is that in the second working example, the contact portion 37 of the lever 30 is used in order to lift up the holding member 20, while in the fourth working example, the contact portion 37 of the lever 30 is used in order to press the holding member 20 downward.

FIG. 15 is sectional views for describing an operation of a lever in the terminal board of the fourth working example, wherein FIG. 4(a) shows a standby state (a state of waiting for an insertion of a crimp terminal) and FIG. 15(b) shows a wired state (a fastened state). In a standby state, the lever 30 is in an upright state, and the opposing portion 37 of the lever opposes an upper face of the inclined portion 22 of the holding member across a slight interval, as seen in FIG. 15(a).

In this state, no pressing force from the lever 30 is acting, and the holding member 20 is in a free state, because of which a gap in which to insert the crimp terminal 2 is formed between an upper face of the base 10 and the lower face of the horizontal portion 21 of the holding member.

When the lever 30 is inverted after the crimp terminal 2 is inserted into the terminal board, the contact portion 36 of the lever comes into contact with the inclined portion 22 of the holding member 20, and a pressing force that presses the inclined portion 22 against the crimp terminal 2 comes into effect, whereby the crimp terminal 2 is fixed. That is, the crimp terminal can be attached and detached simply by operating the lever. Also, the neck portion 4 of the crimp terminal being inserted between the pair of protrusions 41 of the engagement portion 40, and the enlarged portion 5 coming into contact with the protrusions 41, whereby a falling out and a lateral deflection of the crimp terminal may be prevented, is the same as in the case of the second working example.

The terminal board of the fourth working example is also a configuration (including a lever locking mechanism) widely used in existing lever type terminal boards, and is not a configuration unique to the invention. A configuration unique to the invention is that the engagement portion 40 is provided in the insertion opening of the terminal board 1, as in the case of the second working example, thereby preventing a falling out and a lateral deflection of the crimp terminal. As a form and operational advantages thereof are as previously described, these will be omitted.

### BRIEF DESCRIPTION OF DRAWINGS

FIG. 1 is a drawing illustrating an external appearance of a screw fastening type terminal board 100, which is a first working example, and a crimp terminal connection.

FIG. 2 is a perspective view and a sectional view of the screw type terminal board 100, wherein an engagement portion 40 is formed flush with an end face of a frame left side face 130 of the screw fastening type terminal board 100.

FIG. 3 is enlarged sectional views before a crimp terminal 2 is inserted with a bulging portion of a core wire crimping portion 7 at the top or at the bottom.

FIG. 4 is a drawing showing an example of a structure of the engagement portion 40 of a screw fastening type terminal board.

FIG. 5 is a perspective view and a sectional view of a lever type terminal board 1, wherein the engagement portion 40 is formed as a die type flush with an end face of the left side face 130 of a frame 3.

FIG. 6 is a drawing showing an external appearance of a lever type terminal board in which no screw is used, which is a second working example.

FIG. 7 is exploded views showing a structure and a form of parts of the terminal board of the second working example.

FIG. 8 is a drawing showing an example of a structure of the engagement portion 40 of a lever type terminal board.

FIG. 9 is a drawing illustrating an operation of a lever in the terminal board of the second working example.

FIG. 10 is illustrations of the engagement portion 40 of the terminal board of the second working example.

FIG. 11 is an enlarged view of the engagement portion 40 in the terminal board of the second working example.

FIG. 12 is illustrations of a lever type terminal board that is a third working example.

FIG. 13 is illustrations of a form and operational advantages of a pair of claws 25 provided on either leading end side of a holding member in the third working example.

FIG. 14 is sectional views showing a form of a part of a terminal board that is a fourth working example.

FIG. 15 is sectional views for describing an operation of a lever in the terminal board of the fourth working example.

FIG. 16 is an illustration of an operation of fastening a Y-type terminal to a base 110 of the screw fastening type terminal board 100 with a screw 120.

FIG. 17 is a drawing showing forms of a round crimp terminal and a Y-type terminal, and dimensions of copper wire-use bare Y-type terminals with part numbers of a company A, which is a crimp terminal manufacturer.

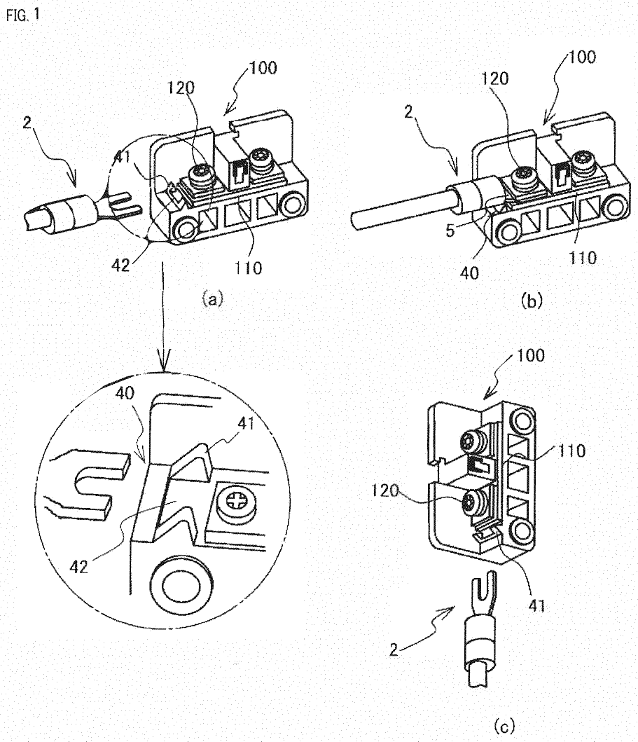

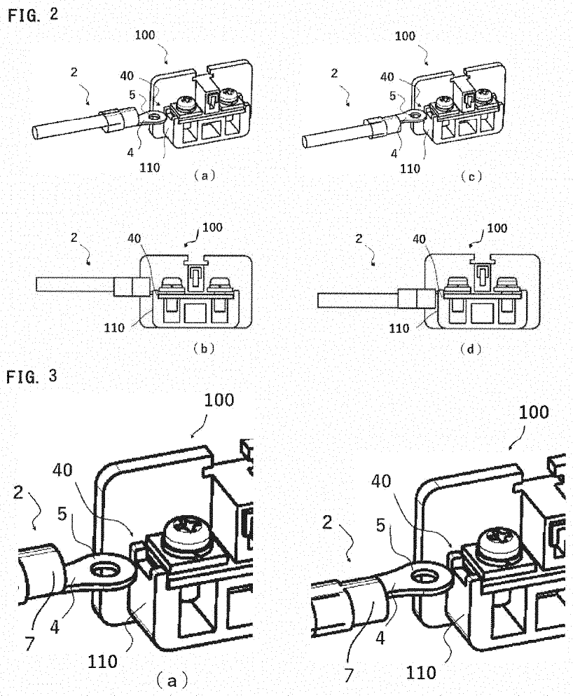

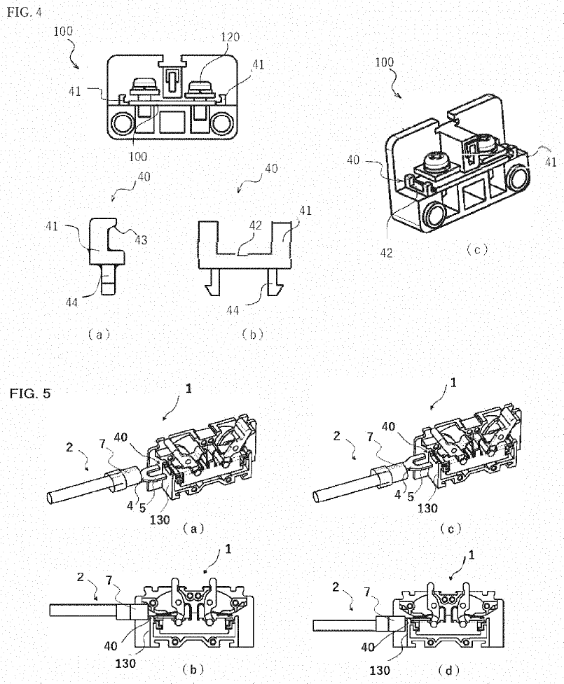

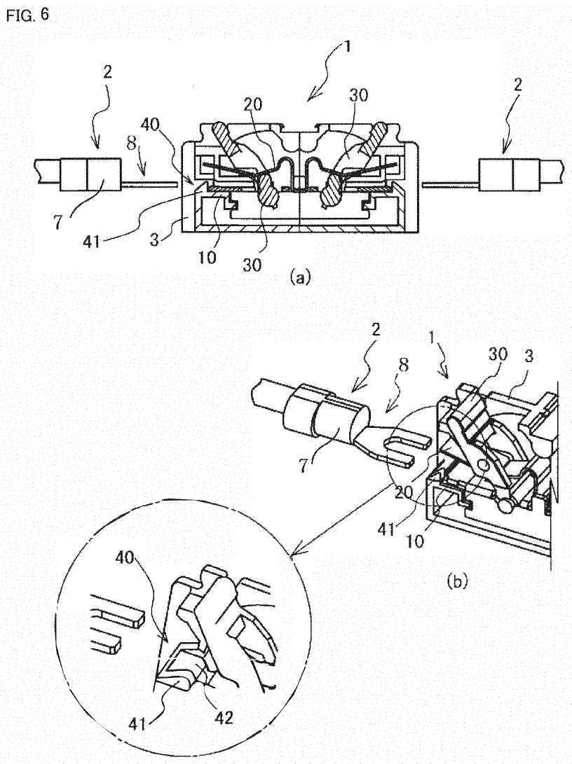

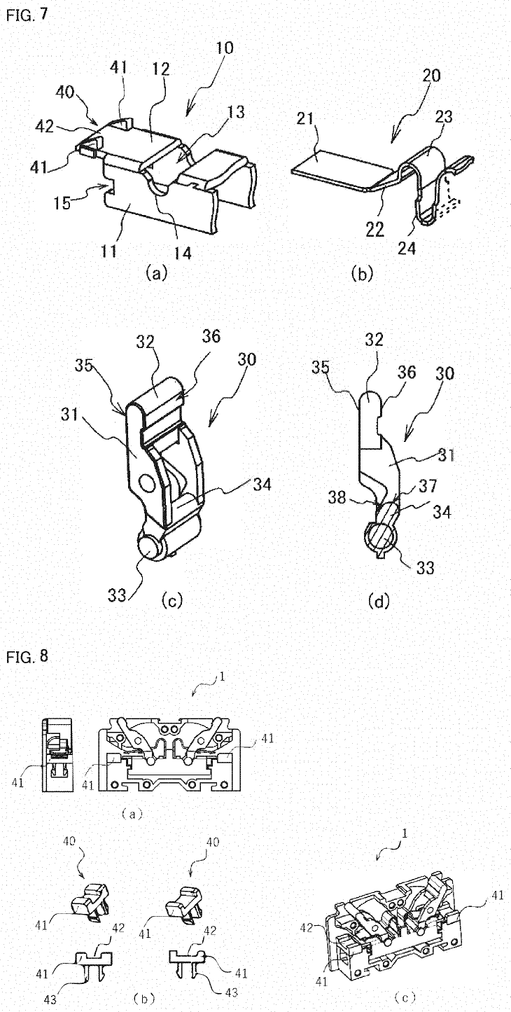

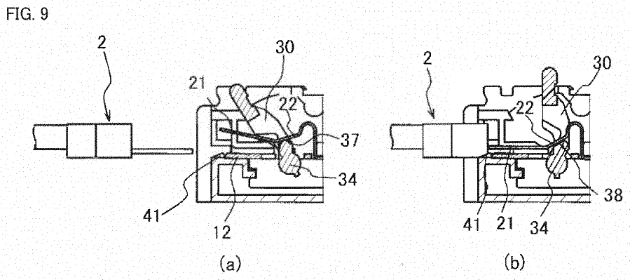

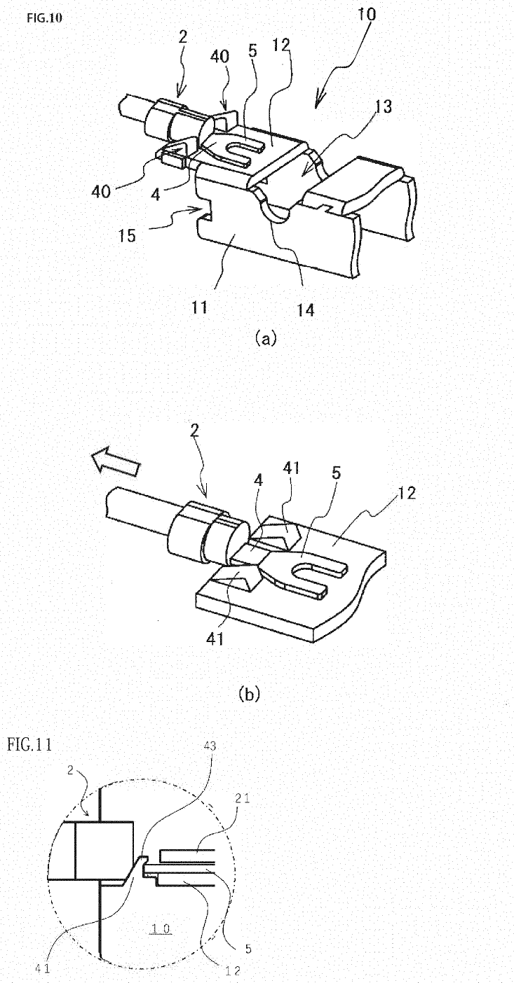

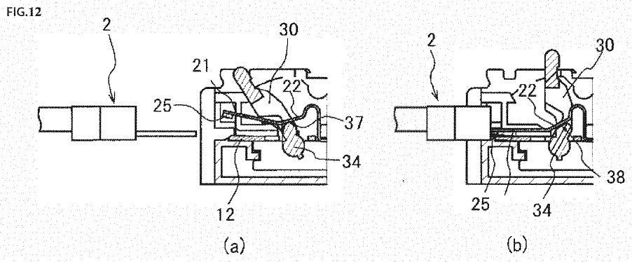

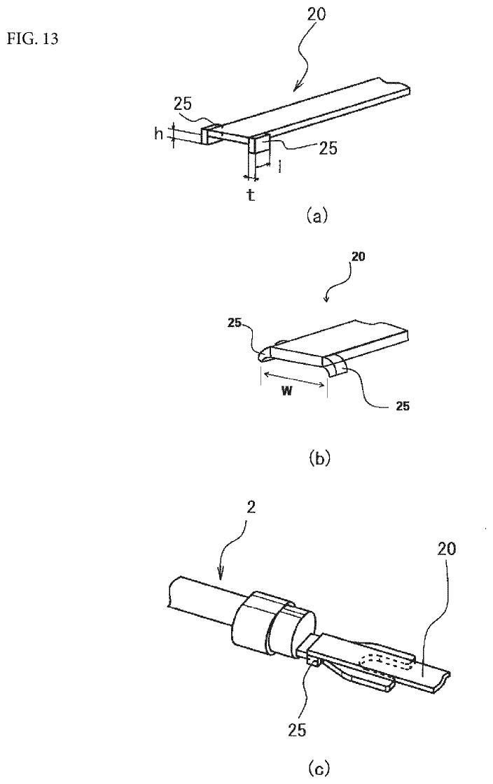

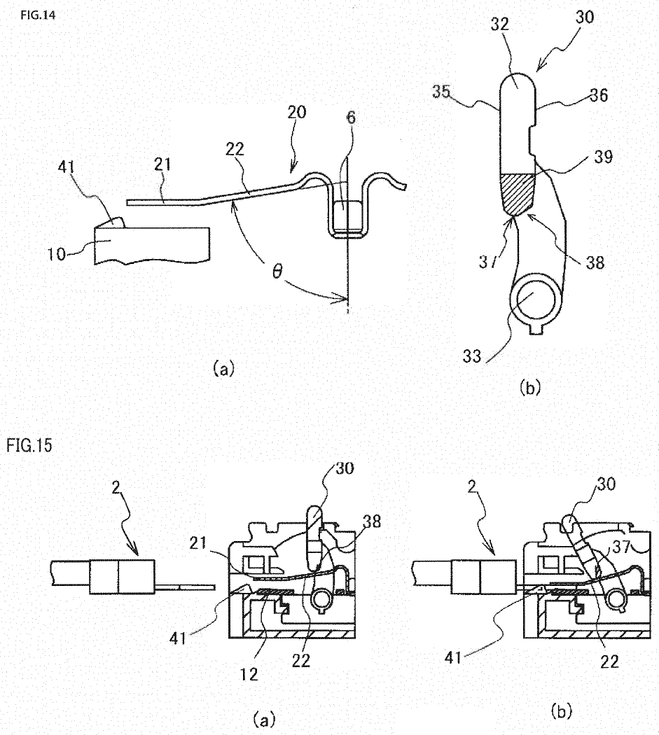

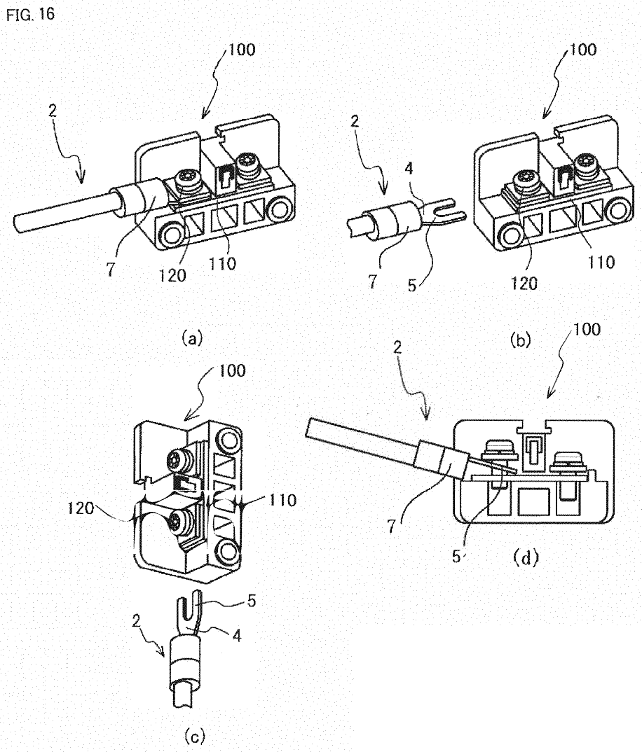

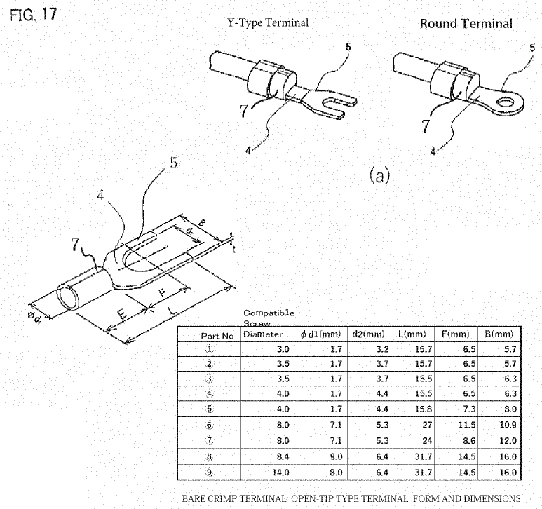

### REFERENCE SIGNS LIST

1: terminal board
2: crimp terminal
3: frame
4: crimp terminal neck portion
5: crimp terminal enlarged portion
6: support protrusion
7: core wire crimping portion
8: tongue portion
10: base
11: side wall
12: projecting portion
13: cutout space
14: bearing
15: cutout portion
20: holding member
21: horizontal portion
22: inclined portion
23: upper curved portion
24: lower curved portion
25: protrusion
30: lever
31: support plate
32: gripping portion
33: rotary axis
34: lower block
35: gripping portion front face
36: gripping portion back face
37: contact portion
38: opposing portion
39: upper block
40: engagement portion
41: protrusion
42: groove
43: projecting portion (chin)
44: support pile
100: screw fastening type terminal board
110: base
120: screw
130: left side face of frame

1. A terminal board, comprising:
an insertion opening into which a crimp terminal including a neck portion and an enlarged portion is inserted;
a base formed of a conductive material and extending in a back side direction from the insertion opening;
a holding member that holds the crimp terminal inserted from the insertion opening between the holding member and the base; and
a bolt that fastens the holding member to the crimp terminal or a lever that controls a state of the holding member holding the crimp terminal, wherein
an engagement portion including a pair of protrusions opposing across an interval wider than a neck portion with a maximum width among neck portions of crimp terminals used in the terminal board, and narrower than an enlarged portion with a minimum width, is provided from an end face of the insertion opening, and an insertion position of the crimp terminal is determined by a core crimping portion of the crimp terminal coming into contact with the protrusions, the base, or an end face of a frame of the terminal board when the crimp terminal is inserted.

2. A terminal board, comprising:
an insertion opening into which a crimp terminal including a neck portion and an enlarged portion is inserted;
a base formed of a conductive material and extending in a back side direction from the insertion opening;
a holding member that holds the crimp terminal inserted from the insertion opening between the holding member and the base; and
a bolt that fastens the holding member to the crimp terminal or a lever that controls a state of the holding member holding the crimp terminal, wherein
an engagement portion including a pair of protrusions opposing across an interval wider than a neck portion with a maximum width among neck portions of crimp terminals used in the terminal board, and narrower than an enlarged portion with a minimum width, is provided in the insertion opening in such a way as to be replaceable in accordance with a form and dimensions of the crimp terminal, and the enlarged portion is engaged with the protrusions when the crimp terminal is inserted, thereby being prevented from falling out.

3. The terminal board according to claim 1 or 2, wherein a projecting portion is provided in an upper portion of the protrusion with which the enlarged portion of the crimp terminal comes in contact.

4. The terminal board according to any one of claims 1 to 3, wherein a pair of claws protruding downward are provided on either width direction side end of a leading end portion of a holding member of a lever that controls a holding state of the crimp terminal.
